(19) United States
(12) Patent Application Publication
(10) Pub. No.: US 2026/0285685 A1
(43) Pub. Date: Sep. 24, 2026

(54) Carbon Nanotube Catalyst Preconditioning

(71) Applicant: Chasm Advanced Materials, Inc., Canton, MA (US)

(72) Inventors: Ricardo A. Prada Silvy, Norman, OK (US); David J. Arthur, Braintree, MA (US)

(73) Assignee: Chasm Advanced Materials, Inc.MA, Canton, MA (US)

(21) Appl. No.: 19/032,766

(22) Filed: Jan. 21, 2025

Related U.S. Application Data
(63) Continuation of application No. PCT/US2024/048603, filed on Sep. 26, 2024.
(60) Provisional application No. 63/541,519, filed on Sep. 29, 2023.

(51) Int. Cl. C01B 32/162; B01J 21/02; B01J 21/04; B01J 23/02; B01J 23/75; B01J 23/78; B01J 35/30; B01J 37/02; B01J 37/08; C01B 32/164

(52) U.S. Cl. CPC C01B 32/162; B01J 21/02; B01J 21/04; B01J 23/02; B01J 23/75; B01J 23/78; B01J 35/394; B01J 37/0201; B01J 37/0236; B01J 37/08; C01B 32/164; C01B 2202/06; C01P 2002/88; C01P 2004/03; C01P 2004/133

(57) ABSTRACT

A method for preconditioning a supported metal catalyst that is to be used for the continuous, semi-continuous or batch production of carbon nanotubes (CNT) in a reactor, before the catalyst is fed into the reaction chamber at high temperature. The method involves treating an amount of the catalyst in a gas flow at an elevated preconditioning temperature for a preconditioning time.

### CROSS-REFERENCE TO RELATED APPLICATIONS

This application claims priority of PCT/US2024/048603, filed on Sep. 26, 2024, which itself claimed priority of Provisional Patent Application 63/541,519, filed on Sep. 29, 2023. The entire disclosures of these two prior applications are incorporated by reference herein, for all purposes.

### BACKGROUND OF THE INVENTION

Carbon nanotubes are allotropic forms of carbon that are structured like sheets of graphene in a tubular shape. Depending on the number of concentric tubes, these materials are classified as single-walled (SWCNT), double-walled (DWCNT), or multiple-walled (MWCNT) carbon nanotubes. Single-walled nanotubes are commonly used for commercial applications that require high electrical conductivity or as semiconductor materials (transistors, sensors). They are also used in solar panels, fuel cells, water filtration membranes, medical applications, etc. Multi-walled carbon nanotubes are employed in commercial applications that require improvement of the electro-mechanical properties of advanced materials such as polymers, plastics, elastomers, construction materials, etc. They are also used as conductive additives in the manufacture of lithium-ion battery electrodes, supercapacitors, etc.

There are several methods for synthesizing carbon nanotubes, including arc discharge, laser ablation, and Catalytic Chemical Vapor Deposition method (CCVD). The latter employs catalysts based on unsupported or supported active metals on a substrate. The CCVD method is the most widely practiced commercially due to its high product yield, selectivity for tubular carbon, control over chirality and structural defects, lower production cost, and scalability compared to the arc discharge and laser ablation methods, which were used during the discovery of these advanced nanomaterials.

The CCVD method employs catalysts containing nanoparticles of active metals and a carbon source (e.g., CO, acetylene, ethylene, propylene, methane, etc.), which react in a catalytic reactor at temperatures ranging from 500 to 1100° C. and total pressures varying between 1 to 50 atm. The reaction temperature depends on the carbon source used and the type of carbon nanotube to be synthesized (SWCNT, DWCNT, MWCNT, and hybrid materials). The CCVD method, which utilizes metal-supported catalysts, enables better control of chirality and selectivity to CNTs compared to processes that use unsupported metal nanoparticles. Commonly, this method employs fluidized bed, moving bed, or rotating tube reactors.

The choice of the most appropriate reactor for carbon nanotube synthesis depends on various factors, including the type of process (continuous or semi-continuous), the type of nanotube to be synthesized, the properties of the catalyst (particle density and size distribution), and process parameters such as temperature, pressure, gas flow and composition, catalyst feeding, and residence time, etc. Table 1 presents a comparison between fluidized bed reactors and rotary tube reactors and their respective applications in carbon nanotube synthesis.

The catalyst plays a crucial role in the synthesis of carbon nanotubes, and it represents the core component of the process. The characteristics of the carbon nanotubes synthesized, such as the number of walls, aspect ratio (length/diameter of individual tubes or bundles), bundle morphology, presence of structural defects, tubular carbon selectivity, and product yield, are determined by the nature and size of the active metal in the active metal nanoclusters, their composition, the textural properties (surface area and pore volume), morphology, and surface properties of the catalyst support, as well as the CNT synthesis conditions (carbon source, pressure, and temperature).

In some commercial carbon nanotube production processes, the catalyst is fed into the reactor under an inert gas flow at the reaction temperature before contacting the carbon source. Certain catalysts, specifically those based on a high metal composition of the active metal Co (or Ni) supported on alumina, commonly employed for the synthesis of multi-walled carbon nanotubes (MWCNTs) intended for applications in lithium battery electrodes, are thermally unstable. These catalysts may undergo significant changes in active metal surface dispersion (sintering of the particles), specific surface area, and pore volume of the support when continuously fed into the reactor at high temperatures. The presence of a high level of moisture and certain volatile compound impurities in the catalyst can accelerate these metal surface dispersion and catalyst support structural changes. As a result, the catalyst may lose its activity and selectivity properties, which represent significant limitations for the continuous or semi-continuous commercial production of carbon nanotubes when using fluidized bed, moving bed, or rotary tube reactors.

TABLE 1
Comparison between fluidized bed and rotary tube
reactor in the carbon nanotube synthesis.

| Fluidized bed reactor | Rotary tube reactor |
|---|---|
| The intense mixing of catalyst particles | It can utilize a wide variety of catalysts with |
| with the process gas ensures a uniform | different particle sizes and densities. |
| temperature distribution, minimizing the | It reduces the agglomeration of product particles, |
| formation of hot spots in exothermic | preventing CNTs from becoming entangled and |
| reactions and promoting better heat | difficult to disperse. |
| absorption in endothermic reactions. | The reactor is operated continuously for CNT |
| The increased catalytic surface area per | production. |
| unit bed volume results in higher reaction | Due to the low rotation rate of the tube, there is |
| rates. | minimal catalyst fine formation through abrasion, |
| Optimal contact between the process gas | reducing the likelihood of product entrainment. |
| and catalyst particles minimizes the | The partial pressure of the process gas and |
| possibility of mass transfer limitations. | hydrogen generated during the reaction can be |
| It enables optimum chirality control in the | controlled throughout the reaction zone, as the |
| synthesis of SWCNT. | reactor allows for both co-current and counter- |
| It yields high-quality SWCNT and FWCNT | current gas flow. |
| products. | The internal reactor design enhances heat and |
| It can be operated in semi-continuous or | mass transfer between the process gas and |
| batch mode. | catalyst particles. |
| Specific catalyst particle size distribution, | It enables reliable operation at a lower labor cost. |
| density, and mechanical strength | Unlike fluidized bed reactors, this reactor has a |
| properties are required for fluidization and | simple mechanical design, requires low |
| to prevent fines formation due to particle | maintenance, and has lower investment costs. |
| abrasion. | The energy and gas consumption costs are |
| Special reactor designs are necessary for | lower than fluidized bed reactors due to their |
| MWCNT synthesis to control product | smaller size and lower process gas flow |
| property homogeneity during the bed | requirements for producing hundreds to |
| expansion, which causes changes in | thousands of metric tons/years of CNTs. |
| fluidization parameters. | There may be limitations in achieving chirality |
| Changes in reactant partial pressure | control when producing SWCNT. |
| throughout the bed height impact the | |
| reaction kinetics. | |

### SUMMARY OF THE INVENTION

A catalyst preconditioning method that inhibits and enables the control of the sintering of the active phase metal oxide precursor and the textural and structural changes of the catalyst (e.g., alumina) support that occur when catalysts containing high metal loading are fed into a fluidized bed or rotary tube reactor in continuous operation mode under reaction conditions. This catalyst pre-conditioning method facilitates controlled and gradual removal of residual moisture from the calcined catalyst without significantly affecting the carbon yield, selectivity to tubular carbon, the structure, CNT bundle morphology, and conductivity properties of the carbon nanotubes. This catalyst pre-conditioning operation can be carried out in a furnace at temperatures between about 600° C. and about 700° C. by contacting the calcined catalyst with a flow of an inert gas, air, or a mixture of the two, for a contact time of fewer than 20 minutes.

In one aspect a method for preconditioning a supported metal catalyst that is to be used for the continuous, semi-continuous or batch production of carbon nanotubes (CNT) in a reactor, before the catalyst is fed into the reaction chamber at high temperature, includes treating an amount of the catalyst in a gas flow at an elevated preconditioning temperature for a preconditioning time.

In an example the preconditioning temperature is from about 500° C. to about 750° C., preferably between about 550° C. and about 700° C. In an example the preconditioning time is from about 5 minutes to about 20 minutes. In some examples the catalyst support includes calcined aluminum hydroxide. In an example the aluminum hydroxide is calcined at between about 400° C. and about 600° C. for from about 2 hours to about 6 hours.

In an example the catalyst support includes alumina. In an example the catalyst support includes γAl₂O₃ or MgO-γAl₂O₃ or χAl₂O₃ or MgO-χAl₂O₃ or ηAl₂O₃ or MgO-ηAl₂O₃. In an example the metal catalyst includes at least one transition element. In an example the metal catalyst includes Co. In an example the metal catalyst includes at least five weight percent of the supported metal catalyst. In an example the catalyst includes at least one of Co/γAl₂O₃ and Co/MgO-γAl₂O₃.

In an example the reactor is a rotary tube reactor or a fluidized bed reactor. In an example the ratio of gas flow to catalyst is from about 0.25 to about 2.5 liters per gram. In an example the gas is one or both of air and an inert gas. Also included is a preconditioned supported metal catalyst made by these methods.

In another aspect a preconditioned supported metal catalyst for use in the production of carbon nanotubes (CNT) in a reactor includes a γAl₂O₃-based metal catalyst support, with nanocrystals of at least one transition metal on the support, wherein the transition metal includes at least five weight percent of the supported metal catalyst.

In an example the catalyst support includes MgO-γAl₂O₃. In an example the catalyst support includes γAl₂O₃. In an example the at least one transition metal includes Co. In an example the preconditioned supported metal catalyst has a low moisture content as evidenced by its absorption of up to about 5 weight percent moisture from the atmosphere.

In another aspect a method of the continuous production of carbon nanotubes (CNT) in a rotary tube or fluidized bed reactor includes continuously feeding into the reactor at a reaction temperature a preconditioned supported metal catalyst that includes nanocrystals of a transition metal on an alumina-based support that has been preconditioned by treating the catalyst in a gas flow at an elevated preconditioning temperature for a preconditioning time, and at the same time continuously feeding into the reactor a reaction gas mixture comprising a source of carbon and hydrogen, maintaining the reactor at the reaction temperature, maintaining the catalyst in the reactor for at least a reaction time, wherein CNT are grown on the transition metal sites, and then continuously withdrawing from the reactor the catalyst with CNT grown thereon after at least the reaction time in the reactor.

In an example the preconditioning temperature is from about 500° C. to about 750° C. In an example the preconditioning time is from about 5 minutes to about 20 minutes. In an example the catalyst support includes calcined aluminum hydroxide. In an example the aluminum hydroxide is calcined at between about 400° C. and about 600° C. for from about 2 hours to about 6 hours.

In an example the catalyst support includes γAl₂O₃ or MgO-γAl₂O₃. In an example the transition metal includes Co. In an example the metal catalyst includes at least five weight percent of the transition metal. In an example the catalyst includes at least one of Co/γAl₂O₃ and Co/MgO-γAl₂O₃. In an example the ratio of inert gas flow to catalyst during the preconditioning is from about 0.25 to about 2.5 liters per gram.

### BRIEF DESCRIPTION OF DRAWINGS

FIG. 1 illustrates aspects of the solid-state transformation of aluminum hydroxides to alumina.

FIG. 2 includes SEM images showing the effect of the alumina support on the carbon nanotube growth.

FIG. 3 includes SEM images taken at 10 KX magnifications corresponding to the CNT synthesized in both catalytic reactors when the catalyst was fed at room temperature and at reaction temperature.

FIG. 4 illustrates TGA analyses corresponding to the MWCNTs synthesized with the Co/γAl₂O₃ catalyst feed in a fluidized bed reactor at room temperature and at 675° C.

FIG. 5 illustrates an effect of the calcination temperature on the carbon nanotube content in the product.

FIG. 6 includes SEM images taken at 1 KX and 5 KX magnifications corresponding to the MWCNT obtained with the Co/γAl₂O₃ catalyst calcined at 450, 550 and 600° C.

FIG. 7 includes SEM images taken at 100 KX and 200 KX magnifications corresponding to the Co/γAl₂O₃ catalyst calcined at 450° C. and 600° C.

FIG. 8 illustrates X-Ray diffraction patterns corresponding to alumina and Co/γAl₂O₃ catalyst treated at different conditions.

FIG. 9 illustrates an effect of the pre-conditioning treatment of the catalyst at 675° C. on the carbon nanotube content in the product.

FIG. 10 includes SEM images corresponding to the MWCNTs products obtained after preconditioning treatment of Co/γAl₂O₃ catalyst.

FIG. 11 illustrates Activity tests corresponding the preconditioned Co/γAl₂O₃ Catalyst conducted in rotary tube reactor in counter-current process gas flow/catalyst feed.

FIG. 12 includes SEM images corresponding to the MWCNTs obtained in the different reactor runs.

FIG. 13 includes SEM images corresponding to the MWCNT purified samples of Example 5.

FIG. 14 illustrates TGA Analysis corresponding to the MWCNT purified samples of Example 5.

FIG. 15 includes SEM images of catalysts that were subjected to a reduction treatment in a reactor.

FIG. 16 includes SEM images corresponding to catalyst preconditioning in air.

### DETAILED DESCRIPTION OF THE INVENTION

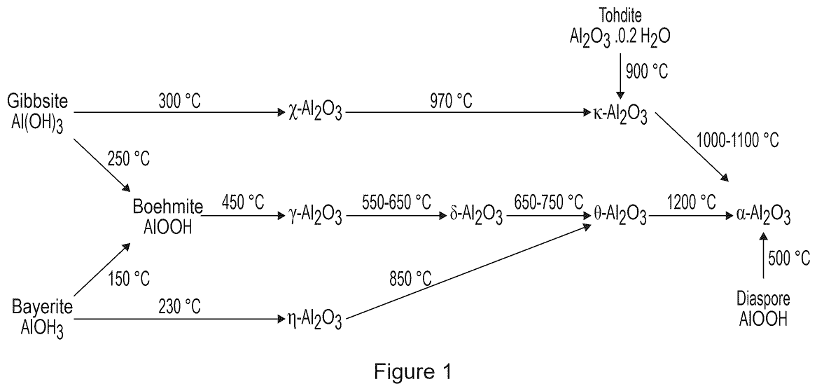

Aluminas are widely used in catalyst manufacture and as industrial adsorbents for different industrial applications. In the commercial production of multi-walled carbon nanotubes, most catalysts use alumina as a support for the active metals. These aluminas are obtained from various aluminum sources. The most common method to obtain the alumina support involves transforming aluminum hydroxides through heat treatments at different temperatures within a furnace. Several aluminum hydroxide precursors can be utilized, including gibbsite, bayerite, boehmite, diaspore, tohdite, etc. FIG. 1 details aspects of aluminum hydroxide precursors and their transformation to alumina.

The most common aluminum hydroxides employed in the preparation of catalysts are oxy-hydroxide boehmite (—AlOOH), gibbsites or bayerite (α-Al(OH)₃). When calcining gibbsite at T>250° C. or bayerite at T>150° C., boehmite is formed, which transforms into γ-alumina at T≥450° C. Gibbsite calcination at T>300° C. produces χ-Al₂O₃. Bayerite calcination at T>230° C. produces η-Alumina. γ-Alumina is a transitional aluminum oxide compound that can be converted into δ-Al₂O₃ and θ-Al₂O₃ at calcination temperatures near 650° C. Formation of δ-Al₂O₃ was observed in γ-Alumina calcined at 550° C. Other transitional aluminum oxide compounds and the calcination temperatures at which they convert to other forms are illustrated in FIG. 1.

γ-Alumina exhibits a defective inverted cubic spinel-like structure with an AAO₄ stoichiometry. In this structure, aluminum atoms (Al⁺² and Al⁺³) occupy interstitial sites in the crystal lattice, specifically tetrahedral (T_{d}) or octahedral (Oₕ) positions, respectively. The percentage of Al⁺² T_{d} cations is approximately 25-34%, while the rest consists exclusively of Al⁺³ Oₕ cations. Structures with vacancies in the spinel Al⁺³ octahedral sites are more stable compared to structures with vacancies in tetrahedral Al⁺² coordination sites.

γ-Alumina contains surface hydroxyl groups (Al—OH) that can act as Brφnsted acid or basic sites during the catalytic reactions. Through a dehydroxylation mechanism, Lewis acid sites (Al+) and water molecules are produced at temperatures above 500° C.

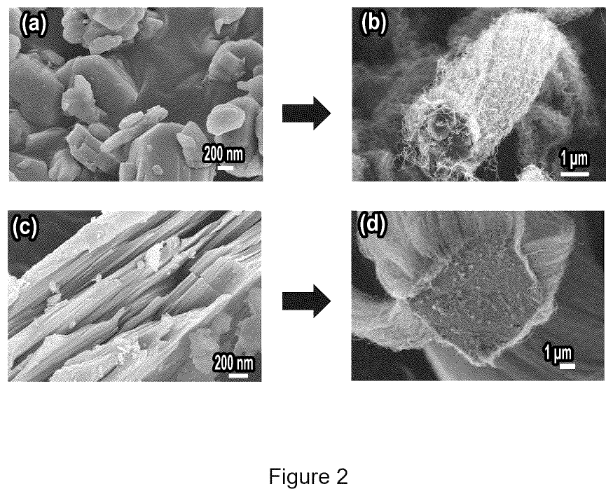

Transmission and scanning electron microscopy (TEM and SEM) studies reveal different predominant structures of γ-Al₂O₃ nanocrystals, including rhombic crystals, lamellar crystals, prismatic crystals, bulkier particles, cubic-octahedral particles, and fibrous particles. The shape and size of the alumina-supported metal-containing catalyst nanocrystals determine the morphological properties of carbon nanotubes. FIG. 2 shows SEM images that illustrate the effect of particle size and the shape of the alumina support crystals on the growth of carbon nanotubes. FIG. 2 image (a) displays rhomboidal-shaped crystals with sizes less than 5 microns. When the catalyst is prepared using this support, the formation of rod-shaped bundles of carbon nanotubes (FIG. 2, image b) is observed. Using lamellar-shaped alumina with crystal sizes around 10 to 20 microns (FIG. 2 image c), a preferential growth of forest-shaped carbon nanotubes is observed on the lateral surface of the crystal (FIG. 2 image d). Active metals tend to be preferentially intercalated between the spaces of the alumina sheets during catalyst preparation.

The temperature and time of the calcination of alumina catalyst supports are two of the process parameters to control since they can influence the textural properties (such as surface area, pore volume and diameter distribution), surface properties (including acidity, basicity, and surface charge (ZPC, IEP), as well as the mechanical properties when the support is subjected to shaping processes. The calcination process for certain industrial catalysts is typically carried out between 40° and 600° C. for a time of 2 to 6 hours, especially for catalysts with high micro-porosity and specific surface area. The calcination time and temperature will depend on the morphological properties of the starting boehmite (pseudo boehmite, well-crystallized boehmite, or lamellar powders).

In continuous carbon nanotube production processes, the presence of moisture in the reaction environment can significantly affect the activity and selectivity properties of the catalyst. Water molecules can lead to an accelerated deactivation of the catalyst through oxidation of the active metals. Moreover, the water molecules can react with the carbon source, giving rise to CO and CO₂. Moisture can also cause sintering of the catalyst active metals and accelerate structural changes causing a significant decrease in the surface area and pore volume of the alumina support. Additionally, the presence of moisture inside the reactor can also cause CNT product agglomeration and particles adhesion problems on the reactor walls, which may require stopping the unit operation to remove the accumulated material. The above technical issues represent a great limitation to produce high carbon yield and controlled morphology carbon nanotubes in commercial processes.

Various sources of moisture can be identified during the catalyst feed into the reactor at high temperature for the synthesis of CNTs. Among them are: moisture from the environment, with water molecules physically adsorbed on the catalyst support. This moisture can be removed from the catalyst through a heat treatment at temperatures between 100-120° C. In some examples this can be conducted in a flow of an inert gas or air or a combination of the two; metal oxides precursors of the active phases, such as Co, Ni, and Fe oxides, tend to be highly hygroscopic; the transformation of residual boehmite into γ-alumina at T>450° C.; the transformation of γ-alumina into δ-Al₂O₃ at T>550° C. can induce dihydroxylation of the support; and the reduction reaction of metal oxides during the activation of the catalyst in initial contact with the source of carbon and hydrogen.

When the calcination temperature is progressively increased above 500° C., several simultaneous effects can occur: Co, Ni, or Fe species react with alumina, displacing aluminum atoms in its crystal lattice from tetrahedral coordination to form Co, Ni, or Fe aluminates. These transition metal aluminate species are stable and remain inactive under carbon nanotube synthesis conditions; as a consequence of the decrease in cobalt (Ni or Fe) atoms on the support surface, the catalytic activity is affected; the γ-alumina can undergo phase changes to δ-alumina and θ-alumina, leading to a loss of crystallinity; the density of the acid sites decreases due to dehydroxylation of the acid sites, and the remaining acid sites become stronger; and the specific surface area and pore volume decrease.

Overall, increasing the calcination temperature can have significant implications for the material's structure and catalytic properties.

To prevent the active metal(s) (e.g., Co Ni and/or Fe) from reacting with alumina and to maintain the catalyst's activity, an alkaline metal (e.g., Mg or Ca) can be included in the catalyst formulation. These alkaline metals form much more stable spinel with the alumina, creating a protective barrier. The oxides of Mg or Ca reduce the surface acidity of the support, preventing the carbon source from undergoing catalytic cracking reactions that could result in the formation of non-tubular carbon species. These non-tubular carbon species can contaminate the final product and negatively impact its quality.

During the calcination of the catalyst, MgAl₂O₄ is formed, and this helps to keep the active metals (Co, Ni, or Fe) on the surface of the support. The presence of MgAl₂O₄ stabilizes the catalyst structure, ensuring that the active metals remain in the right locations for catalytic reactions.

Both the calcination temperature and time are relevant factors that influence these transformations. Calcination conditions can be chosen to achieve the desired catalyst structure and properties. This involves finding the balance between promoting the formation of stable spinel, like MgAl₂O₄, and maintaining the catalyst's activity by preventing excessive reactions between the active metals and alumina. In summary, the inclusion of alkaline metals in the catalyst formulation and controlling the calcination conditions help preserve the catalyst's activity, stability, and selectivity during the carbon nanotube synthesis process.

In this disclosure, the limitations presented above were resolved by preparing catalysts based on Co/γAl₂O₃ and Co/MgO-γAl₂O₃. This was achieved by contacting an aqueous solution containing a Co salt or Co and Mg salts with an alumina precursor (Al(OH)₃) to form a paste. The paste is subsequently aged under controlled temperature and moisture content, and then dried progressively at different temperatures to control the thermal decomposition of the salts. The dried solid is ground and sieved to the desired particle size and then calcined at a moderate temperature to control the textural properties (surface area, pore volume, pore size distribution) of the catalyst and to prevent the active metal from reacting with alumina to form an inactive CoAl₂O₄ phase. The calcined catalyst was preconditioned in the presence of a flow of inert gas and/or air at temperatures between 60° and 700° C. to progressively remove excess moisture and any volatile compounds from the catalyst. The preconditioning temperature, residence time, and amount of catalyst at the preconditioning temperature in the presence of the gas are at least some of the process parameters that can be controlled.

The preconditioned Co/MgO-γAl₂O₃ catalyst is then fed continuously into a fluidized bed or rotating tube reactor at the carbon nanotube synthesis temperature. The reactor in this example is thus operated in continuous mode as compared to batch or semi-continuous mode. The rotary tube reactor can be operated with a co-current or countercurrent reaction gas flow to the catalyst feed, preferably countercurrent.

For the synthesis of carbon nanotubes, different carbon sources are used, such as ethylene, propylene, propyne, ethane, methane, carbon monoxide, etc. The reaction temperature depends on the reactivity of the carbon source and the properties of both the catalyst and the type of carbon nanotube to be synthesized. This temperature can vary between 400° C. and 1100° C., generally between 600° C. and 700° C. when ethylene, propylene, or ethane is used as the carbon source. In general, the percentage of the carbon source varies between 60 and 90 vol % of the process gas. During carbon nanotube synthesis, a flow of H₂ and N₂ is introduced into the reactor to improve fluidization conditions and thermal conductivity, promote catalyst activation, and prevent the formation of non-tubular carbon species. The residence time of the catalyst in the fluidized bed or rotary reactor is 10 to 20 minutes. Under these conditions, carbon yield greater than 85% and controlled MWCNT morphology (high CNT aspect ratio, rods bundle shape) are obtained.

Examples follow:

### Example 1

In this example, two catalysts according to the invention were prepared. One was based on Co/γAl₂O₃ and the other on Co/MgO-γAl₂O₃. The catalysts were prepared according to the following procedure. For the first catalyst, a solution containing cobalt nitrate was contacted with Al(OH)₃ having rhomboidal-shaped crystals with sizes less than 5 microns in a mixer to form a paste. In the second catalyst, a magnesium nitrate salt was added to the cobalt nitrate solution. The Co, MgO and Al₂O₃ molar composition (Co:Al₂O₃ and Co:MgO:Al₂O₃) in the catalysts are 14:70 and 14:1:70, respectively. The impregnated materials were subsequently aged at room temperature for 2 hr., and then dried at 60° C. for 3 hours and finally at 120° C. for 2 hours in air flow. The dried solid particles were sieved to a grain size between 100 and 300 μm and calcined in air flow at 450° C. for 3 h.

The synthesis of carbon nanotubes was carried out in a fluidized bed reactor (FBR) and in a rotary tube reactor (RTR) which were operated in semi-continuous mode under the following conditions:

For the fluidized bed reactor, the process gas contained 80 v % ethylene and 20 v % of H₂, a space velocity (WHSV) of 180 L C₂H₄/g·cat·h, a reaction temperature of 675° C. and reaction time of 20 minutes. For the rotary tube reactor, the process gas contained 60 v % ethylene, 20 v % H₂ and 20 v % N₂, the catalyst residence time in the reaction zone was about 20 minutes and the ethylene flow/catalyst feed ratio was 3 l/gr.

In a first set of experiments, in both fluidized bed and rotary kiln reactors, the catalyst was fed at room temperature and then heated under N₂ flow up to 675° C. Subsequently, the process gas was introduced into the reactor to facilitate carbon nanotube synthesis. In a second set of experiments, the catalyst was fed into both fluidized bed and rotary tube reactors under a nitrogen flow at the reaction temperature, and then the carbon nanotube synthesis was performed.

Table 2 summarizes the results obtained from the carbon nanotube synthesis in both FBR and RTR catalytic reactors operated in batch mode for the experiments conducted with the Co/γAl₂O₃ and Co/MgO-γAl₂O₃ catalysts.

TABLE 2
Influence of the catalyst feed temperature
on the MWCNT content in the product.

| | Co/MgO-γAl₂O₃ | Co/γAl₂O₃ | MWCNT content |
|---|---|---|---|
| | catalyst feed | catalyst feed | in the |
| | temperature (° C.) | temperature (° C.) | product (wt %) |
| Fluidized bed | Room | — | 93 |
| reactor | | | |
| Fluidized bed | — | Room | 94 |
| reactor | | | |
| Fluidized bed | — | Room | 92 |
| reactor | | | |
| Rotary tube | Room | — | 92 |
| reactor | | | |
| Fluidized bed | — | 675 | 56 |
| reactor | | | |
| Rotary tube | — | 675 | 55 |
| reactor | | | |
| Rotary tube | 675 | — | 58 |
| reactor | | | |

When both Co/γAl₂O₃ and Co/MgO-γAl₂O₃ catalysts are fed at room temperature in both fluidized bed and rotating tube reactors, the percentage of MWCNT obtained in the product is between 92 and 94 wt %. However, when both catalysts were fed into the FBR and RKR at the reaction temperature, the carbon yield decreased dramatically, resulting in MWCNT contents in the product between 55-58 wt %.

The analysis of the textural properties of the Co/γAl₂O₃ catalyst calcined at 450° C. revealed a decrease in BET surface area from 275 m²/g to about 196 m²/g when the catalyst was fed into the reactor at 675° C. This represents a loss of approximately 30% in specific surface area. The pore volume also decreased from 0.26 cc/g to about 0.23 cc/g, indicating an approximate loss of 12% in pore volume.

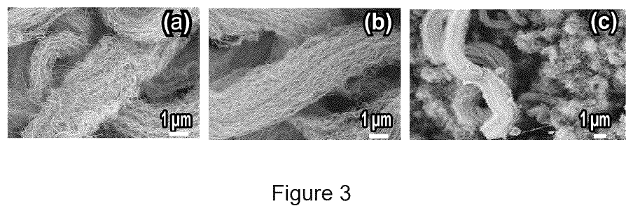

FIG. 3 shows SEM images corresponding to the carbon nanotubes synthesized in both catalytic reactors when the catalyst was fed at room temperature and at 675° C. We can observe similar morphological properties of the carbon nanotubes when the catalyst is fed at room temperature in both the fluidized bed and rotary tube reactors (FIG. 3 image a and FIG. 3 image b, respectively). However, a combination of highly agglomerated rods and cotton ball-like CNT bundles structures can be observed when the catalyst was fed into the rotary tube reactor at 675° C. The electron microscopy micrograph reveals the presence of defective CNTs, some of them having a large diameter, spring-type tubes, and carbon fiber formations (FIG. 3 image c).

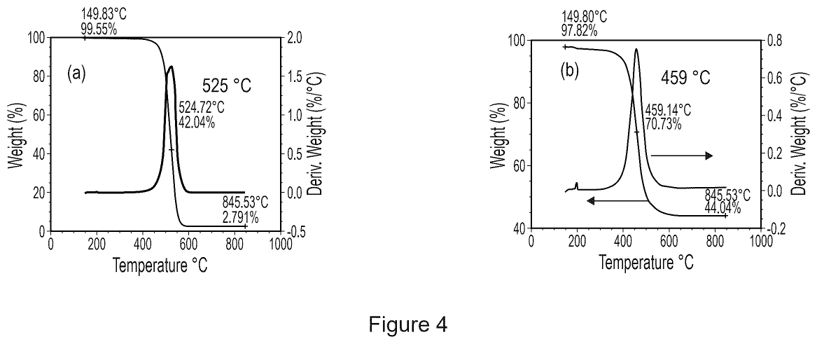

The thermogravimetric analysis of the synthesized carbon nanotubes provided in FIG. 4 reveal a decrease in the maximum rate of oxidation temperature (from 525° C. when the catalyst is fed into the reactor at room temperature, left graph of FIG. 4, to about 459° C. when the catalyst was fed into the reactor at 675° C., right graph of FIG. 4). These changes are mainly attributed to the high Co content in the residual catalysts as well as the presence of defective tubes and different morphologies of the carbon nanotube aggregates.

### Example 2

Thermogravimetric analyses were carried out for the alumina and the catalysts calcined at 450, 500, 550 and 600° C. for three hours in a furnace, where the weight loss was determined at a temperatures of about 500° C., 550° C., 600° C., 675° C., and 850° C. (left column of Table 3) for each of the samples. Table 3 shows slight differences in weight loss between the alumina and the calcined catalyst as a function of temperature increase. At 675° C., the weight loss for both the alumina and the catalyst was 4.01 wt % and 3.92 wt %, respectively, a difference of approximately 2.2%.

When the calcination temperature was increased from 450° C. to 600° C., a progressive reduction in the weight loss of the catalyst was observed. This is due to structural changes in the alumina phases at high temperatures, which involve the loss of H₂O through a dehydroxylation mechanism. As a result, the specific surface area and pore volume of the alumina support decrease, thereby reducing the adsorption of water from the atmosphere. Cobalt oxides tend to be hygroscopic. However, when its particles sinter at high temperatures or react with the alumina to produce cobalt aluminate, the amount of water adsorbed on the metal oxide decreases. At 675° C., the weight loss was around 2.10 wt %, which represents a reduction of approximately 46% compared to the catalyst calcined at 450° C.

TABLE 3
TGA analysis corresponding to the Al₂O₃ and the Co/
γAl₂O₃ calcined at 450, 500, 550 and 600° C.

| | | Co/γAl₂O₃ | Co/γAl₂O₃ | Co/γAl₂O₃ | Co/γAl₂O₃ |
|---|---|---|---|---|---|
| | Alumina | catalyst | Catalyst | catalyst | catalyst |
| | calcined at | calcined | calcined | calcined | calcined |
| | 450° C. | at 450° C. | at 500° C. | at 550° C. | at 600° C. |
| Temperature | weight loss | weight loss | weight loss | weight loss | weight loss |
| (° C.) | (wt. %) | (wt. %) | (wt %) | (wt. %) | (wt. %) |
| 500 | 2.79 | 2.75 | 2.30 | 1.79 | 1.58 |
| 550 | 3.28 | 3.16 | 2.56 | 1.97 | 1.69 |
| 600 | 3.65 | 3.51 | 2.84 | 2.21 | 1.85 |
| 675 | 4.01 | 3.92 | 3.20 | 2.55 | 2.10 |
| 850 | 4.33 | 4.47 | 3.79 | 3.16 | 2.63 |

The specific surface area of the catalysts calcined at different temperatures decreased as follow: 275 m²/g (at 450° C.), 222 m²/g (at 500° C.), and 209 m²/g (at 550° C.).

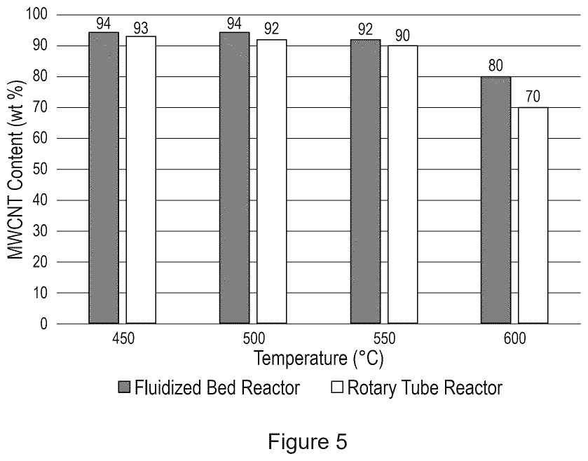

Catalytic activity tests of the calcined catalysts at different temperatures were carried out in both fluidized bed and rotary tube reactors in semicontinuous operation mode under the reaction conditions described in Example 1. The results of the synthesis of carbon nanotubes (in both fluidized bed and rotary tube reactors) are presented in FIG. 5. It is observed that the percentage of MWCNT in the product is greater than 90 wt % for the calcination temperature range (x-axis) between 450° C. and 550° C. However, the catalyst that was calcined at 600° C. showed a loss of activity, and the percentage of MWCNT obtained was around 80 wt % for the fluidized bed reactor and 70 wt % for the rotary tube reactor.

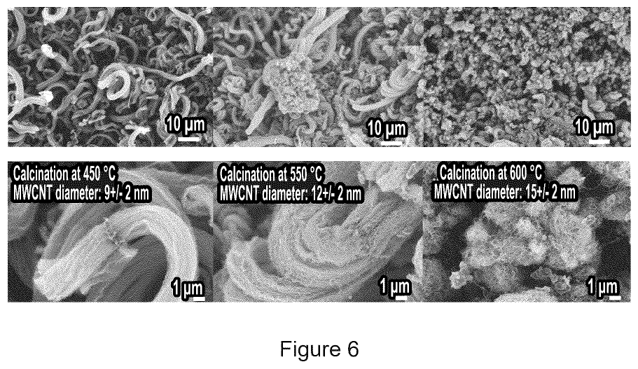

The carbon nanotubes synthesized from the calcined catalysts at different temperatures were analyzed by scanning electron microscopy. FIG. 6 shows SEM images obtained at 1 KX (top row of three images) and 5 KX (bottom row of three images) magnifications corresponding to the carbon nanotubes synthesized with the Co/γAl₂O₃ catalyst calcined at 450° C. (the left column of two images), 550° C. (the middle column of two images), and 600° C. (the right column of two images). Significant changes can be clearly seen both in the morphology of the carbon nanotube bundles and in the diameter of the tubes as a function of calcination temperature. At 450° C., rod-shaped bundles of MWCNT are observed. The diameter of the individual tubes is approximately 9+/−2 nm, corresponding to 6 and 10 concentric tubes. By progressively increasing the calcination temperature of the catalyst, the formation of aggregates of carbon nanotubes in the form of cotton balls are visible. At 550° C. and 600° C. calcination, the micrographs show the formation of both rod-like and cotton ball-like structures of MWCNT. In this case, the external diameter of the tubes is approximately 12+/−2 nm and 15+/−2 nm, respectively. A greater formation of CNTs cotton balls-like structure is observed in the sample calcined at 600° C.

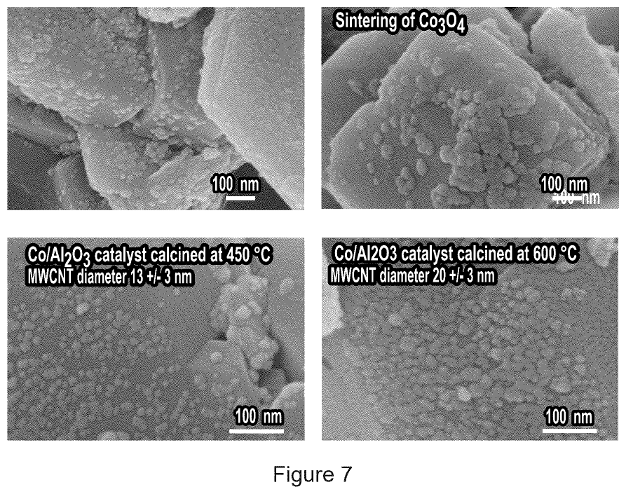

FIG. 7 shows SEM images taken at 100 KX (top row of two images) and 200 KX (bottom row of two images) magnifications corresponding to the Co/γAl₂O₃ catalyst calcined at 450° C. left column of two images) and 600° C. (right column of two images). The images of the catalyst calcined at 450° C. show particles of the Co₃O₄ oxide active phase precursor dispersed on both the lateral and basal surfaces of the alumina crystals. The average size of these cobalt oxide particles is approximately 13+/−3 nm. Images of the catalyst calcined at 600° C. show strong agglomeration of cobalt oxide particles on both basal and lateral surfaces. Mostly, these Co₃O₄ particles, with an average size of 20+/−3 nm, are located on the basal surface of the alumina crystals.

The results of the SEM analysis of the calcined catalysts (FIG. 7) and the carbon nanotubes (FIG. 6), along with TGA (Table 3) and BET S.A. analysis of the catalysts calcined at different temperatures, can be directly correlated with the catalytic activity results shown in FIG. 5. The SEM analysis in FIG. 6 clearly shows changes in the morphology of the bundles and the diameter of the carbon nanotubes as the calcination temperature progressively increases. Furthermore, the surface area and pore volume of the catalysts continuously decrease with increasing calcination temperature.

Agglomeration of cobalt oxide active phase precursor particles was evidenced by the SEM analysis of the catalyst calcined at 600° C. Sintering of the Co₃O₄ phase and modifications in the structural and textural properties of the alumina support occurred at high calcination temperatures, which clearly explains the activity loss of the catalyst and the changes in the CNT morphology properties.

### Example 3

As previously highlighted, the presence of high moisture content in the Co/γAl₂O₃ and Co/MgO-γAl₂O₃ catalysts can accelerate changes in the structure and morphology properties of the alumina support, as well as the sintering of the supported Co₃O₄ active phase precursor when the catalysts are fed into the reactor under carbon nanotube synthesis conditions. As shown in Example 2, calcining the catalyst at temperatures between 50° and 600° C. to remove moisture content does not result in a feasible technical solution because the morphology of the carbon nanotube bundles, and diameter of the tubes, are affected by the high calcination temperatures. It was also observed that these catalysts showed a carbon yield lower than 90% when the rotary tube reactor was operated in continuous mode.

To solve these technical difficulties, a series of experiments were carried out where the Co/γAl₂O₃ catalyst calcined at 450° C. was subjected to a pre-conditioning treatment before being fed into the reactor. This pre-treatment consists of gradually and controllably removing moisture from the catalyst through a treatment in the presence of a flow of inert gas (N₂) and/or air at determined temperatures and for a short time. The temperature and the contact time of the catalyst under the pre-conditioning conditions are parameters to control.

Tables 4 and 5 show the effect of the catalyst pre-conditioning temperature and time on the MWCNT content in the product, respectively. The pre-conditioning time corresponding to the set of experiments conducted at different temperatures was 10 minutes. In these experiments, the N₂ flow/amount of catalyst ratio was about 1.0 l/min·g. The CNT synthesis was conducted in a rotary tube reactor in continuous operation mode under the experimental conditions described in Example 1.

The results of Table 4 clearly show that increasing the pre-conditioning temperature in the range of 450° C. to 600° C. causes a progressive increase in the MWCNT content in the product. Between 600° C. and 675° C., the amount of CNTs in the product remains constant (about 90 wt %).

Table 5 shows the effect of pre-conditioning time on the MWCNT content in the product. These experiments were conducted at a pre-conditioning temperature of 675° C. The MWCNT content in the product remains almost the same for the samples pre-conditioned at 5 and 10 minutes, and then it decreases at 20 minutes pre-conditioning time.

The specific surface area of the preconditioned catalyst at 675° C. for 10 minutes only experienced a slight decrease to about 228 m²/g (about 17% lower than that of the Co/γAl₂O₃ non-preconditioned catalyst, Example 1).

TABLE 4
Effect of the preconditioning temperature
on the MWCNT content in the product.

| Preconditioning | MWCNT |
|---|---|
| Temperature | content (wt %) |
| 450 | 55 |
| 500 | 56 |
| 550 | 69 |
| 600 | 90 |
| 675 | 91 |

TABLE 5
Effect of the preconditioning time on
the MWCNT content in the product.

| Preconditioning | MWCNT |
|---|---|
| Time (min) | content (wt %) |
| 5 | 90 |
| 10 | 91 |
| 20 | 87 |

Thermo-gravimetrical analysis was conducted on the Co/γAl₂O₃ catalyst calcined at 450° C. after preconditioning treatment at 675° C. for 10 minutes (Table 6). The results show that the weight loss at 675° C. is approximately 2.20 wt %, a decrease of about 44% compared to the weight loss observed for the catalyst calcined at 450° C. before preconditioning treatment.

TABLE 6
TGA analysis corresponding to the Co/γAl₂O₃ catalyst
preconditioned at 675° C. for 10 minutes.

| | Co/γAl₂O₃ Catalyst |
|---|---|
| Temperature | preconditioned at 675° C. |
| (° C.) | weight loss (wt %) |
| 500 | 1.94 |
| 550 | 2.07 |
| 600 | 2.17 |
| 675 | 2.20 |
| 850 | 2.75 |

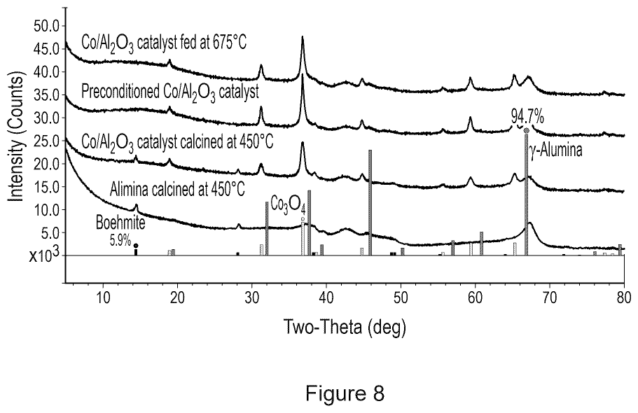

X-ray diffraction analyses (see FIG. 8) were carried out on the following samples: i) the alumina and the Co/γAl₂O₃ catalyst calcined at 450° C. (the second graph curve from the bottom), ii) the catalyst pre-conditioned at 675° C. for 10 minutes (the second graph curve from the top), and iii) the catalyst (non-preconditioned) fed into the reactor at 675° C. (the top graph curve). Alumina calcined at 450° C. is shown on the bottom graph curve. Both the alumina and the Co/γAl₂O₃ catalyst, calcined at 450° C., show X-ray diffraction signals characteristic of boehmite and γ-alumina. The analysis indicated that about 6% wt of the aluminum atoms are present as boehmite. There are some additional X-ray diffraction signals not yet identified, which presumably correspond to χ-Al₂O₃ according to the literature (see FIG. 1).

When the Co/γAl₂O₃ catalyst was preconditioned or fed into the reactor at 675° C., the signal corresponding to boehmite disappeared, and the intensity of the Co₃O₄ peaks increased. This is attributed to an increase in the metal composition of the catalyst due to the transformation of the residual boehmite into alumina and the phase transformation of alumina.

### Example 4

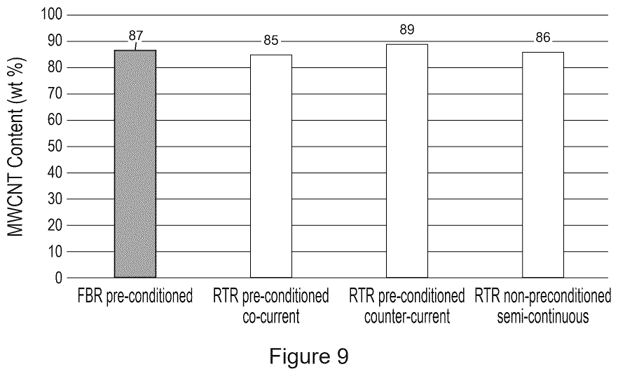

In this series of experiments, the Co/γAl₂O₃ catalyst was preconditioned at 675° C. with a N₂ flow/amount of catalyst ratio of 0.33 L/min·g. The catalytic properties of the catalyst were evaluated in both the fluidized bed (FBR) and rotary tube (RTR) reactors. In both tests, the catalyst was fed into the reactor under reaction conditions. The rotary tube reactor operated continuously, and the process gas flow was fed in co-current and counter-current with respect to the catalyst feed. The results of these experiments are shown in FIG. 9.

The catalyst preconditioning treatment resulted in a significant recovery of the catalytic activity, leading to MWCNT contents in the product greater than 85 wt % in both tests conducted in the fluidized bed and rotary tube reactors. Operating the rotary tube reactor continuously and in counter-current mode provides better benefits since the moisture produced during catalyst activation is rapidly removed from the reactor without affecting its activity or reacting with the carbon source molecules to produce CO and CO₂ during the synthesis of carbon nanotubes.

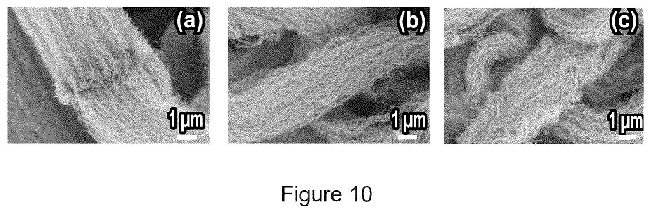

FIG. 10 shows three SEM images taken at 10 KX magnification of the MWCNTs obtained after preconditioning the Co/γAl₂O₃ catalyst and performing catalytic activity tests in both fluidized bed and rotary tube reactors. As can be seen, the images exhibit the same tube morphology observed when the catalyst was fed to the reactor at room temperature, as shown in SEM images in example 2, FIG. 3 image a and FIG. 3 image b.

### Example 5

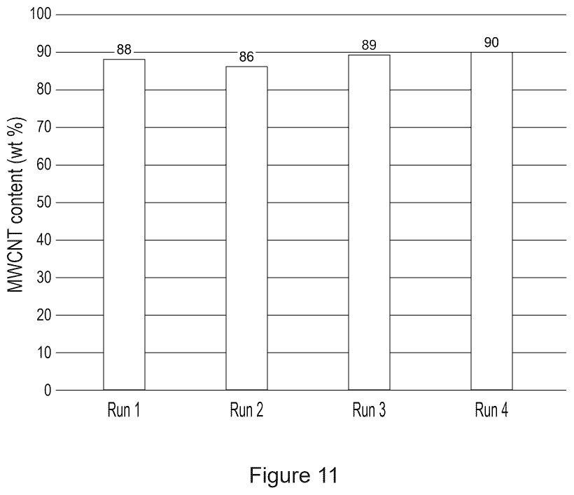

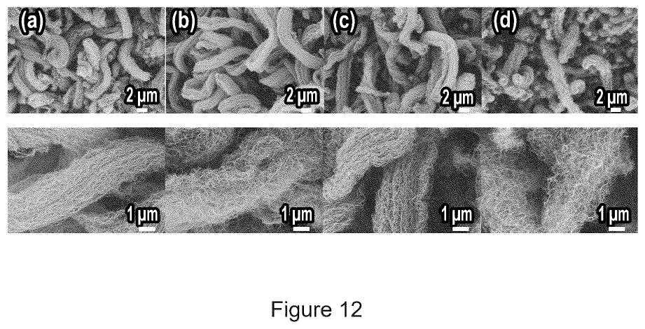

In this example, several reactor runs were carried out to demonstrate the reproducibility of the results obtained when the Co/γAl₂O₃ catalyst was preconditioned, and the catalytic activity tests were conducted in the rotating tube reactor with continuous operation and gas/catalyst countercurrent flow. The results of these catalytic activity tests are represented in FIG. 11. FIG. 11 clearly shows that the content of MWCNT in the product ranges between 86 and 90 wt %. SEM images of the samples obtained from the different reactor runs in FIG. 12 (left column a of two images for run 1, second from left column b of two images for run 12, third from left column c of two images for run 3, and right-most column d of two images for run 4) show the same morphological properties of the carbon nanotubes obtained in example 1, as shown in FIG. 3 image a and FIG. 3 image b.

### Example 6

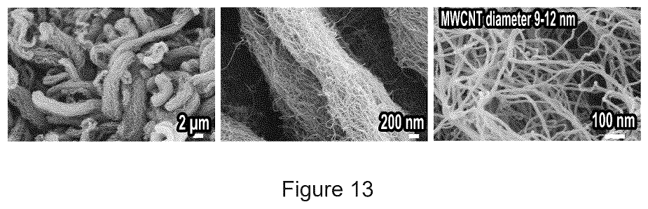

The carbon nanotubes synthesized in Example 5 were purified using an acid solution containing 5 v % hydrofluoric acid (HF) to remove the residual catalyst particles from the product. FIG. 13 shows three SEM images of the purified sample at different magnifications, where the rod-shaped bundles of MWCNT are clearly observed. The diameter of the tubes varies between 9 and 12 nm. The purity of the material, determined through the ash method, is greater than 99.0 wt %.

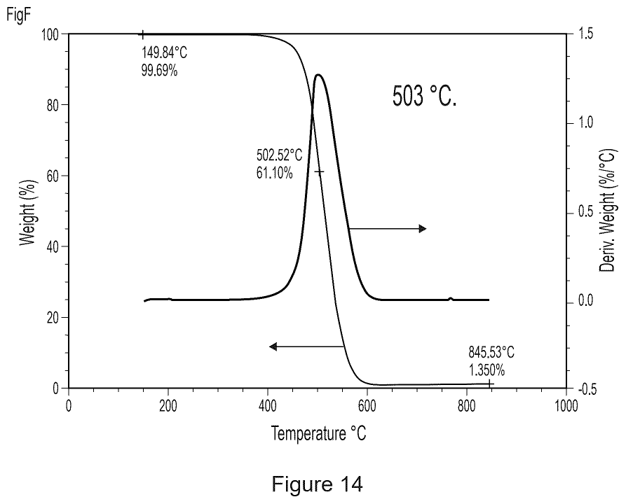

FIG. 14 shows the TGA analysis of the purified product. The temperature corresponding to the maximum combustion rate is 503° C. The nanotubes showed a specific surface area of 305 m²/g and an electrical conductivity, measured through the Bucky Paper technique of analysis, of 1237 ohms/sq, which is comparable with the electrical conductivity of purified carbon nanotubes, synthesized in the fluidized bed reactor, with a catalyst that was fed in a N₂ flow at room temperature (1287 ohms/sq).

### Example 7

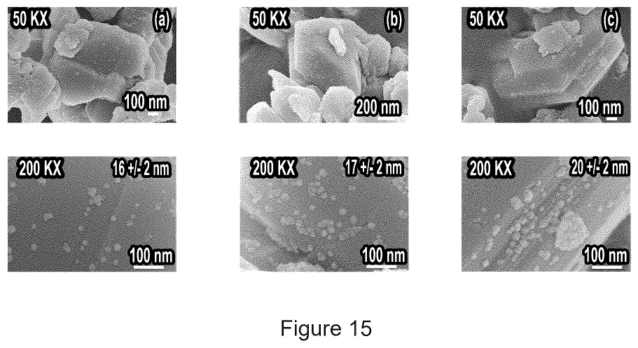

SEM analysis was conducted on the following catalysts that were subjected to a reduction treatment in a reactor using an H₂ flow, at 500° C. for 20 minutes: i) the catalysts calcined at 450° C. (left column (a) of two images in FIG. 15), ii) the catalyst preconditioned at 675° C. for 20 minutes (middle column (b) of two images in FIG. 15), and iii) the catalyst fed into the reactor at 675° C. (right column (c) of two images in FIG. 15). SEM images taken at 50 KX (top row of three images) and 200 KX (bottom row of three images) magnifications revealed highly dispersed metallic cobalt particles in the sample calcined at 450° C. (left column), with an average particle size of 16±2 nm. The dispersion of these metallic particles decreased slightly, and the particle sizes did not change significantly for the preconditioned sample at 675° C. (middle column (b)). A high degree of aggregation is observed for the sample fed into the reactor at 675° C., and the average particle size in this latter sample increased to about 20±2 nm (right column (c)).

### Example 8

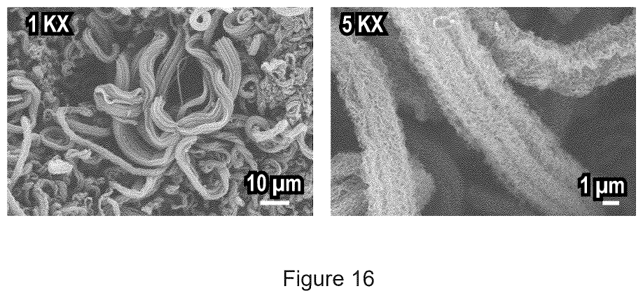

In this example, the Co supported on alumina catalyst underwent a preconditioning treatment in a furnace at 650° C. under an air flow for 10 minutes. Its catalytic properties were evaluated in a rotary tube reactor at 675° C. using ethylene as the carbon source and a residence time of 20 minutes. The MWCNT content, determined through ash analysis, was 91 wt %. FIG. 16 shows SEM images at 1 KX (left image) and 5 KX (right image) magnifications, revealing MWCNTs with a bundle morphology, lengths over 10 microns, bundle diameters between 2-3 microns, and individual tube diameters between 8-12 nm. These properties are similar to MWCNTs obtained using nitrogen as the treating gas in the catalyst pre-conditioning process.

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

1. A method for preconditioning a supported metal catalyst that is to be used for the continuous, semi-continuous or batch production of carbon nanotubes (CNT) in a reactor, before the catalyst is fed into the reaction chamber at high temperature, the method comprising: treating an amount of the catalyst in a gas flow at an elevated preconditioning temperature for a preconditioning time.

2. The method of claim 1, wherein the preconditioning temperature is from about 500° C. to about 750° C., preferably between about 550° C. and about 700° C.

3. The method of claim 1, wherein the preconditioning time is from about 5 minutes to about 20 minutes.

4. The method of claim 1, wherein the catalyst support comprises calcined aluminum hydroxide.

5. The method of claim 4, wherein the aluminum hydroxide is calcined at between about 400° C. and about 600° C. for from about 2 hours to about 6 hours.

6. The method of claim 1, wherein the catalyst support comprises alumina.

7. The method of claim 1, wherein the catalyst support comprises γAl₂O₃ or MgO-γAl₂O₃ or χAl₂O₃ or MgO-χAl₂O₃ or ηAl₂O₃ or MgO-ηAl₂O₃.

8. The method of claim 1, wherein the metal catalyst comprises at least one transition element.

9. The method of claim 1, wherein the metal catalyst comprises Co.

10. The method of claim 1, wherein the metal catalyst comprises at least five weight percent of the supported metal catalyst.

11. The method of claim 1, wherein the catalyst comprises at least one of Co/γAl₂O₃ and Co/MgO-γAl₂O₃.

12. The method of claim 1, wherein the reactor comprises a rotary tube reactor or a fluidized bed reactor.

13. The method of claim 1, wherein the ratio of gas flow to catalyst is from about 0.25 to about 2.5 liters per gram.

14. The method of claim 1, wherein the gas comprises one or both of air and an inert gas.

15. A preconditioned supported metal catalyst made by the method of claim 1.

16. A preconditioned supported metal catalyst for use in the production of carbon nanotubes (CNT) in a reactor, comprising:
a γAl₂O₃-based metal catalyst support, with nanocrystals of at least one transition metal on the support, wherein the transition metal comprises at least five weight percent of the supported metal catalyst.

17. The preconditioned supported metal catalyst of claim 16, wherein the catalyst support comprises MgO-γAl₂O₃.

18. The preconditioned supported metal catalyst of claim 16, wherein the catalyst support comprises γAl₂O₃.

19. The preconditioned supported metal catalyst of claim 16, wherein the at least one transition metal comprises Co.

20. The preconditioned supported metal catalyst of claim 16, with a low moisture content as evidenced by its absorption of up to about 5 weight percent moisture from the atmosphere.

21. A method of the continuous production of carbon nanotubes (CNT) in a rotary tube or fluidized bed reactor, comprising:
continuously feeding into the reactor at a reaction temperature a preconditioned supported metal catalyst comprising nanocrystals of a transition metal on an alumina-based support that has been preconditioned by treating the catalyst in a gas flow at an elevated preconditioning temperature for a preconditioning time;
at the same time continuously feeding into the reactor a reaction gas mixture comprising a source of carbon and hydrogen;
maintaining the reactor at the reaction temperature;
maintain the catalyst in the reactor for at least a reaction time, wherein CNT are grown on the transition metal sites; and then
continuously withdrawing from the reactor the catalyst with CNT grown thereon after at least the reaction time in the reactor.

22. The method of claim 21, wherein the preconditioning temperature is from about 500° C. to about 750° C.

23. The method of claim 21, wherein the preconditioning time is from about 5 minutes to about 20 minutes.

24. The method of claim 21, wherein the catalyst support comprises calcined aluminum hydroxide.

25. The method of claim 24, wherein the aluminum hydroxide is calcined at between about 400° C. and about 600° C. for from about 2 hours to about 6 hours.

26. The method of claim 24, wherein the catalyst support comprises γAl₂O₃ or MgO-γAl₂O₃.

27. The method of claim 24, wherein the transition metal comprises Co.

28. The method of claim 24, wherein the metal catalyst comprises at least five weight percent of the transition metal.

29. The method of claim 24, wherein the catalyst comprises at least one of Co/γAl₂O₃ and Co/MgO-γAl₂O₃.

30. The method of claim 24, wherein the ratio of inert gas flow to catalyst during the preconditioning is from about 0.25 to about 2.5 liters per gram.
